(19) United States
(12) Patent Application Publication
(10) Pub. No.: US 2002/0102945 A1
(43) Pub. Date: Aug. 1, 2002

(54) Transmit-receive switching circuit and method of wireless communication system

(76) Inventors: Kon-Hee Lee, Seoul (KR); In-Hee Lee, Yongin-shi (KR)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/771,986

(22) Filed: Jan. 30, 2001

(51) Int. Cl. H04B 1/40

(52) U.S. Cl. 455/73; 455/82; 455/83; 455/88; 455/560; 455/311; 455/313

(57) ABSTRACT

A transmit-receive switching circuit of a wireless communication system comprises a selecting portion for switching the communication system in a waiting mode into a master; a controller for determining a transmit-receive frequency according to the operating of the selecting portion and generating a control signal; a band selecting portion for selecting an inputting signal of an upper band or a lower band of a receiving signal passed through an antenna and a duplexer according to the control signal of the controller; a first switching portion for selecting an upper band pass filter and a lower band pass filter that are operated by the band selecting portion; an amplifying portion for amplifying a receive signal passing through the switching portion; a second switching portion for switching the receive signal amplified at the amplifying portion according to the operating signal of the band selecting portion and determining to be supplied to an upper band filter or a low band pass filter of a second filtering portion; a mixer for mixing the receive signal passing through the second filter with a local oscillating frequency from a local oscillator; a filtering portion for filtering an intermediate frequency from the mixed frequency; and a transmit mode determining portion for determining/transmitting a transmit frequency according to a signal outputted from the band selecting portion. Therefore, as any one of the wireless mobile communication systems is determined as a master to try the communication, the master switches the transmit-receive frequency bands into those contrary to the slave, thereby preventing the intervention of the transmit-receive frequencies with the slave and enabling the communication between the master and the slave at the same time.

### BACKGROUND OF THE INVENTION

The invention is related to providing a wireless communication system, and particularly, to providing a transmit-receive switching circuit and method for switching a transmit-receive frequency into a corresponding transmit-receive channel, alternatively.

In other words, the transmit-receive switching operation is performed so that as a master transmits a frequency from its upper channel for the communication, a slave receives the frequency into its upper channel and transmits another frequency from its lower channel, while the master receives from its lower channel, in which the transmit-receive frequencies are switched into different channels not to intervene each other. Herein, it is noted that the wireless communication system generally means “Mobile Radio Equipment” divided into the master and the slave.

### PRIOR ART

In general, the wireless communication system uses FRS of the mobile radio communication, for which a communication frequency is first set between a master and a slave, the master transmits a predetermined information to the slave, the slave switches the receive mode into the transmit mode in order to transmit information in response to the information from the master and the master switches the transmit mode into the receive mode so as to receive information in response to the information from the slave.

If the simultaneously communication occurs between the master and the slave, the mater is always set to place a transmit channel on an upper band and a receive channel on a lower band, while the slave is adjusted to place a transmit channel on a lower band and a receive channel on an upper band. The communication uses a half-duplex communication method with the same frequency, because the transmit-receive frequency band is fixed.

The communication method and system has problems in that it is convenient for users to switch a system into a predetermined mode upon every transmit-receive operating for the communication and to use the fixed transmit-receive frequency for a full-duplex communication between the master and the slave.

Accordingly, in order to resolve the problems and disadvantages described above, an object of the invention is to provide a transmit-receive switching circuit and method of a wireless communication system for switching a transmit-receive frequency into a corresponding transmit-receive channel, alternatively.

The other object of the invention is to provide a transmit-receive switching circuit and method of a wireless communication system for preventing the intervention at a frequency channel between a master and a slave to enable the simultaneous communication.

### SUMMARY OF THE INVENTION

In order to accomplish the objects of the invention, a transmit-receive switching circuit of a wireless communication system comprises a selecting portion for switching the communication system in a waiting mode into a master; a controller for determining a transmit-receive frequency according to the operating of the selecting portion and generating a control signal; a band selecting portion for selecting an inputting signal of an upper band or a lower band of a receiving signal passed through an antenna and a duplex according to the control signal of the controller; a first switching portion for selecting an upper band pass filter and a lower band pass filter that are operated by the band selecting portion; an amplifying portion for amplifying a receive signal passing through the switching portion; a second switching portion for switching the receive signal amplified at the amplifying portion according to the operating signal of the band selecting portion and determining to be supplied to an upper band filter or a low band pass filter of a second filtering portion; a mixer for mixing the receive signal passing through the second filter with a local oscillating frequency from a local oscillator; a filtering portion for filtering an intermediate frequency from the mixed frequency; and a transmit mode determining portion for determining/transmitting a transmit frequency according to a signal outputted from the band selecting portion.

A transmit-receive switching method comprises steps of setting a receiving channel at an upper channel and a transmit channel at a lower channel upon the operating of a communication system and switching the communication system into a waiting mode; judging whether the communication system is a master to try the communication; switching the transmit-receive channel, automatically, to place the transmit channel on the upper band and the receive channel on the lower band, firstly, if it is determined as the master; performing the transmit-receive operating at a state determined by the first transmit-receive channel switching step; judging whether the transmit-receive operating is finished and switching the transmit-receive mode into the waiting mode if finished; judging whether the communication system is a slave, if the communication system is not the master at the mater judging step; and switching the transmit-receive channel, automatically, to place the transmit channel on the upper band and the receive channel on the lower band, secondly, if it is determined as the slave.

### BRIEF DESCRIPTION OF THE DRAWINGS

The invention now ill be described in detail with reference to the accompanying drawings, in which:

FIG. 1 is a view illustrating a transmit-receive switching circuit of a wireless communication system according to the invention; and,

FIG. 2 is a flow chart illustrating the operating of a transmit-receive switching circuit of a wireless communication system according to the invention.

### DETAILED DESCRIPTION OF THE INVENTION

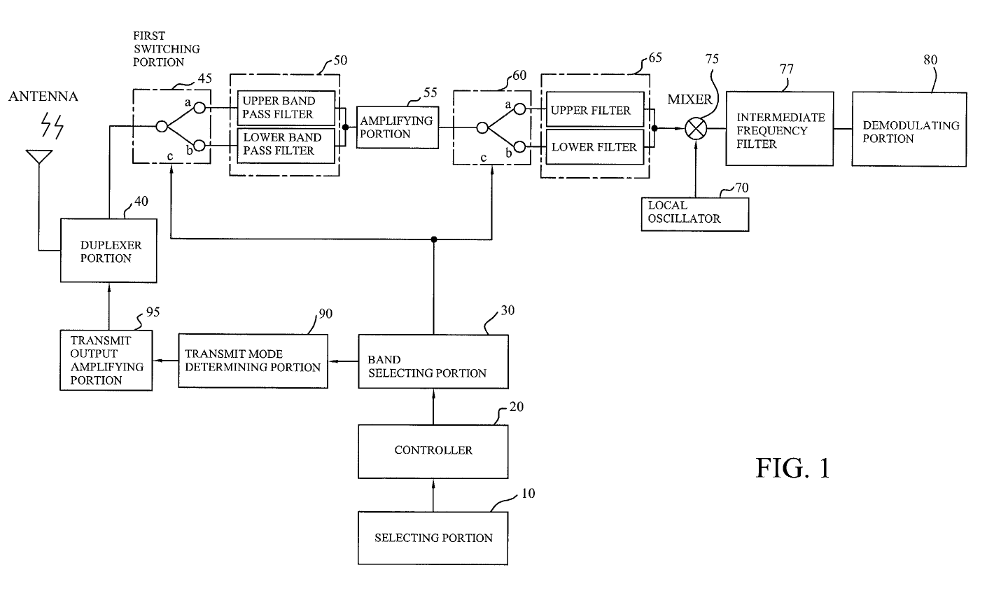

Referring to FIG. 1, a controller 20 is connected to a selecting portion 10 to determine a transmit-receive frequency according to the selection of the selecting portion 10, which converts a communication system to be waited for the communication into a master, and output a control signal. A band-selecting portion 30 outputs an operating signal for selecting the upper channel and the lower channel according to the control signal from the controller 20.

A first switching portion 45 includes an antilog switch that is switched according to the operating signal from the band selecting portion 30 and for determining whether a receive signal passing through an antenna and a duplex portion is supplied to an upper band pass filter or a lower band pass filter of a first filtering portion 50. A second switching portion 60 is switched according to the operating signal of the band-selecting portion 30 to supply a signal filtered by the first filtering portion 50 and then amplified by an amplifying portion 55 to an upper filter or a lower filter of a second filtering portion. Herein, if the master is operated to transmit using the lower band and receive using the upper band, only the upper filters of the first and second filtering portions 50 and 65 are operated to permit a predetermined frequency, for example a frequency of 449.1375 MHz to be passed there through, while the lower filters becomes the non-operating and doesn't permit the frequency of 449.1375 MHz to be not passed there through. On the contrary, the slave is operated to transmit a predetermined frequency using lower bands and receive a predetermined using upper bands, in which the transmit frequency is 424.1375 MHz and the receive frequency is 424.1375 MHz. That is, the transmit frequency is not allowed to pass through first and second filtering portion, and only the receive frequency is passed through the first and second filtering portion.

A mixer 75 mixes a receive signal from the second filtering portion with a local oscillating frequency from a local oscillator 70. An intermediate frequency filtering portion 77 filters an intermediate frequency from the frequency mixed. A demodulating portion 80 demodulates a signal from the second filtering portion 65 and a signal from the mixer 75 and outputs a signal demodulated thereby. A transmit mode determining portion 90 determines a transmit frequency according to the signal from the band selecting portion 30 and enable the transmit frequency to be amplified passing through a transmit output amplifying portion 95 and then passed through the duplex portion 40 and the antenna in order, thereby transmitting a predetermined frequency to another communication system.

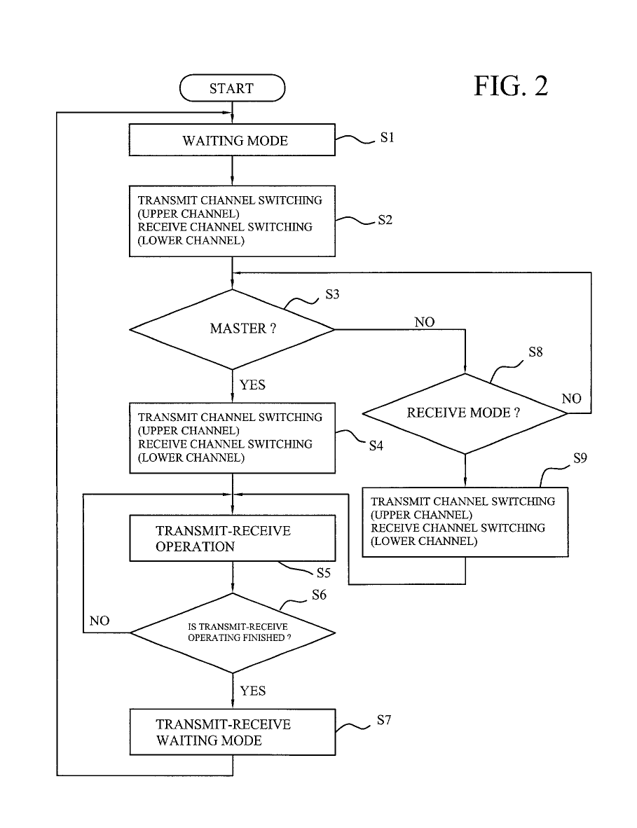

The operation of the transmit-receive switching circuit as described above now will be described in detail with reference to the flow chart of FIG. 2.

As a wireless communication system provided with the trans-receive switching circuit according to the invention operated with a power source being applied thereto, it is switched into a waiting mode as step S1. Step S1 goes to step S2 that the controller 20 is judge whether the selecting portion 10 is operated or not. In other words, assuming that the communication system is a master, the controller 20 forces the transmit mode determining portion 90 to determine a transmit frequency of 449.1375 MHz and supply it through the transmit output amplifying portion 95 to the antenna, while it outputs a control signal to the band selecting portion 30 to convert a receiving signal into a frequency of 449.1375 MHz, in which the band selecting portion 30 applies a control signal to the control terminals of the first and second switching portion 45 and 60, so that their moving terminals are connected to the normal terminals. Therefore, a transmit channel is placed on the upper channel of the filtering portion 50 and a receive channel is set at the lower channel of the filtering portion 50, that a receive signal passes through the antenna and the duplex portion 40 and then is filtered at the lower channel, and vice versa.

After the switching of the transmit-receive channel, step S2 goes to step S3 that it is judged whether the communication system is a master. If so, step S3 proceeds to step S4 that the transmit-receive channels are respectively fixed on the upper channel and the lower channel. At step S5, the communication system becomes the master to perform the transmit-receive operation with the slave. Step S5 goes to step S6 that it is judged whether the transmit-receive operating is finished. If the controller 20 identifies the operating of the selecting portion 10, for example the selecting portion 10 returns to the original position or receives an inputting signal such as the communication suspension from an outside, step S6 proceeds to step S7 that the communication system is set at the waiting mode of the transmit-receive.

On the other hand, if it is judged that the communication system is not the master at step S2, step 2 goes to step S8 that it is judged whether the communication system is in a receive-mode. If the communication system is being switched into the receive mode, step S8 goes to step S9 that the transmit channel is switched into the upper channel of the first filtering portion 50 and the receive channel is switched into the lower channel of the first filtering portion 50.

As described above, a master to be transmitted or a slave to be received for the communication is automatically switched into their designated transmit-receive channel to prevent the intervention of the transmit-receive frequencies with each other at the frequency channel.

What is claimed is:

1. A transmit-receive switching circuit of a wireless communication system comprising:
a selecting portion for switching a communication system in a waiting mode into a master;
a controller for determining a transmit-receive frequency according to the operating of the selecting portion and generating a control signal;
a band selecting portion for selecting an inputting signal of an upper band or a lower band of a receiving signal passing through an antenna and a duplexer according to the control signal of the controller;
a first switching portion for selecting any one of an upper band pass filter and a lower band pass filter that are operated by the band selecting portion;
an amplifying portion for amplifying a receiving signal passed through the switching portion; a second switching portion for switching the receiving signal amplified at the amplifying portion according to the operating signal of the band selecting portion to determine on supplying it to an upper band filter or a low band pass filter of a second filter;
a mixer for mixing the receiving signal passing through the second filter with a local oscillating frequency from a local oscillator;
a filtering portion for filtering an intermediate frequency from the mixed frequency; and,
a transmit mode determining portion for determining/transmitting a transmit frequency according to a signal outputted from the band selecting portion.

2. A transmit-receive switching method comprising steps of:
judging whether the communication system is a master to try the communication;
switching the transmit-receive channel, automatically, to place the transmit channel on the upper band and the receive channel on the lower band, firstly, if it is determined as the master;
performing the transmit-receive operating at a state determined by the first transmit-receive channel switching step;
judging whether the transmit-receive operating is finished and switching the transmit-receive mode into the waiting mode if finished;
judging whether the communication system is a slave, if the communication system is not the master at the mater judging step; and
switching the transmit-receive channel, automatically, to place the transmit channel on the upper band and the receive channel on the lower band, secondly, if it is determined as the slave.
